(19) United States
(12) Patent Application Publication
(10) Pub. No.: US 2013/0090948 A1
(43) Pub. Date: Apr. 11, 2013

(54) SYSTEM AND METHOD FOR HEALTHCARE PRODUCT ENROLLMENT

(71) Applicant: Wellpoint, Inc., Chicago, IL (US)

(72) Inventors: Prakash Upadhyayula, Plainfield, IL (US); Sean Banerjee, Haymarket, VA (US)

(73) Assignee: WELLPOINT, INC., Chicago, IL (US)

(21) Appl. No.: 13/645,650

(22) Filed: Oct. 5, 2012

Related U.S. Application Data
(60) Provisional application No. 61/544,774, filed on Oct. 7, 2011.

(51) Int. Cl. G06Q 50/22

(52) U.S. Cl. CPC G06Q 50/22
USPC 705/3; 705/2

(57) ABSTRACT

Systems, methods and computer-readable media for use in connection with healthcare product enrollment. Data describing health profile information from a consumer is received. This data may be based on historical claims information or on responses to survey questions received from the consumer. The data may be for the individual alone, or for his dependents as well. Data describing cost of care information is determined based on the data describing the health profile information. At least one recommended health care coverage product for the consumer is determined based on the cost of care information. In some embodiments, a consumer cost associated with each of the recommended health care coverage product is conveyed to the consumer.

### CROSS REFERENCE TO RELATED APPLICATIONS

This application claims priority to U.S. Provisional Patent Application No. 61/544,774 filed Oct. 7, 2011, the entirety of which is incorporated herein by reference.

### FIELD OF THE INVENTION

The systems and methods described herein relate to healthcare product enrollment.

### SUMMARY OF EMBODIMENTS OF THE INVENTION

The present invention is directed to systems, methods and computer-readable media for use in connection with healthcare product enrollment. Data describing health profile information from a consumer is received. This data may be based on historical claims information or on responses to survey questions received from the consumer. The data may be for the individual alone, or for his dependents as well. Data describing cost of care information is determined based on the data describing the health profile information. At least one recommended health care coverage product for the consumer is determined based on the cost of care information. In some embodiments, a consumer cost associated with each of the recommended health care coverage product is conveyed to the consumer.

### BRIEF DESCRIPTION OF THE DRAWINGS

FIG. 1 is a conceptual illustration of the systems and methods of one embodiment of the present invention;

FIG. 2 is a diagram of an exemplary system of the present invention;

FIG. 3 is an exemplary method of the present invention;

FIGS. 4-13 are exemplary user interfaces that may be used in accordance with one embodiment of the present invention;

FIG. 14 is a conceptual illustration of the personalized total cost projection engine of the present invention; and

FIG. 15 is a diagram of an exemplary system of the present invention.

### DETAILED DESCRIPTION

A focus of healthcare payors is to provide the best healthcare value to its members. Part of the value is generated in the product/benefit selection process in which members enroll into benefits that provide the best healthcare value. Enrollment is an annual process and creates an opportunity for members to evaluate their healthcare needs on an ongoing basis. Healthcare reform is empowering consumers with the option of comparing healthcare insurance options (private healthcare plans offered by employers, private healthcare plans purchased by individuals, or government sponsored healthcare plans) and enrolling in the right healthcare plan. This greater flexibility also leads to bigger responsibility and accountability for each individual in making informed, educated decisions.

The systems and methods described herein provide consumers with additional transparency in healthcare plan options. This transparency is derived from the processes, methodologies and outcomes as described. Consumers will be better informed about the overall cost of care and thereby make educated decisions in selecting the right healthcare plan based on their specific needs that will provide the consumers with the most value for their money spent.

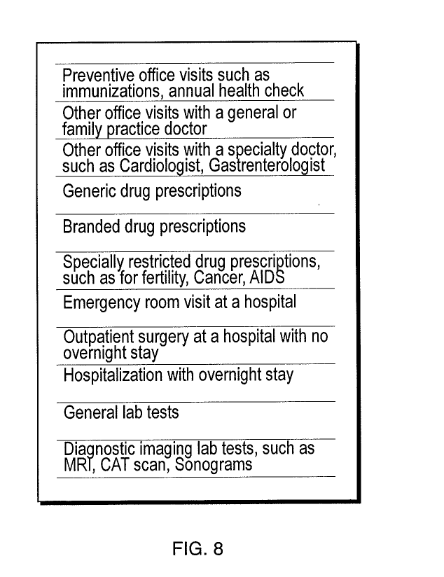

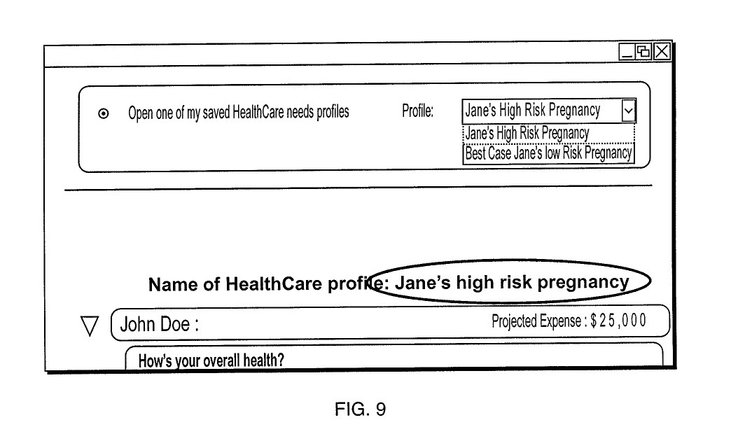

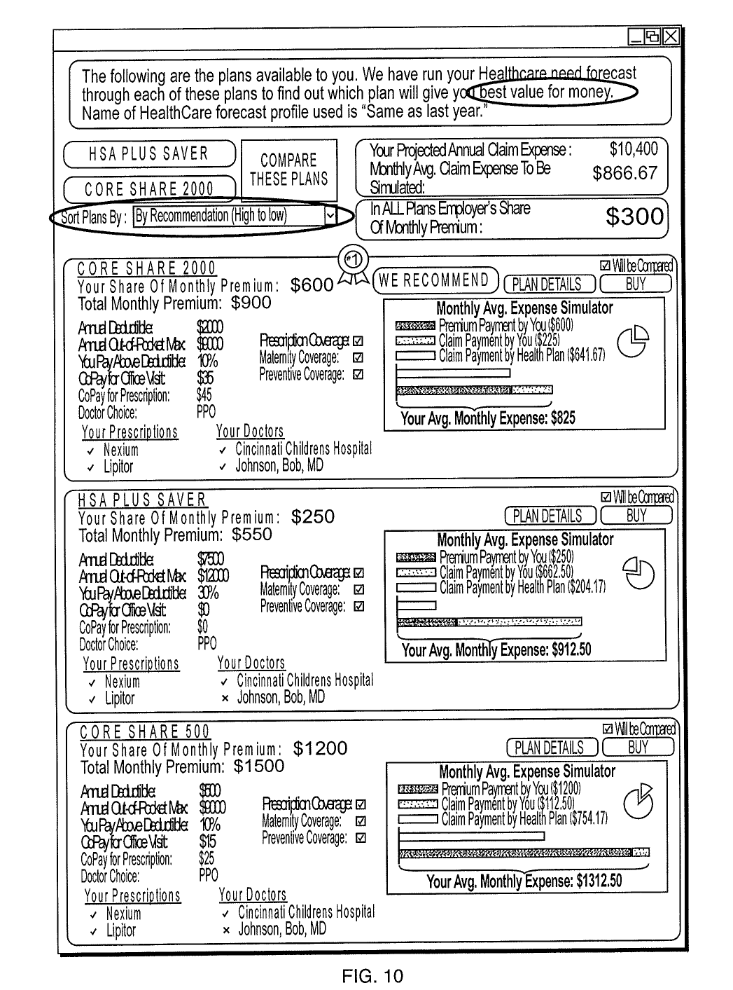

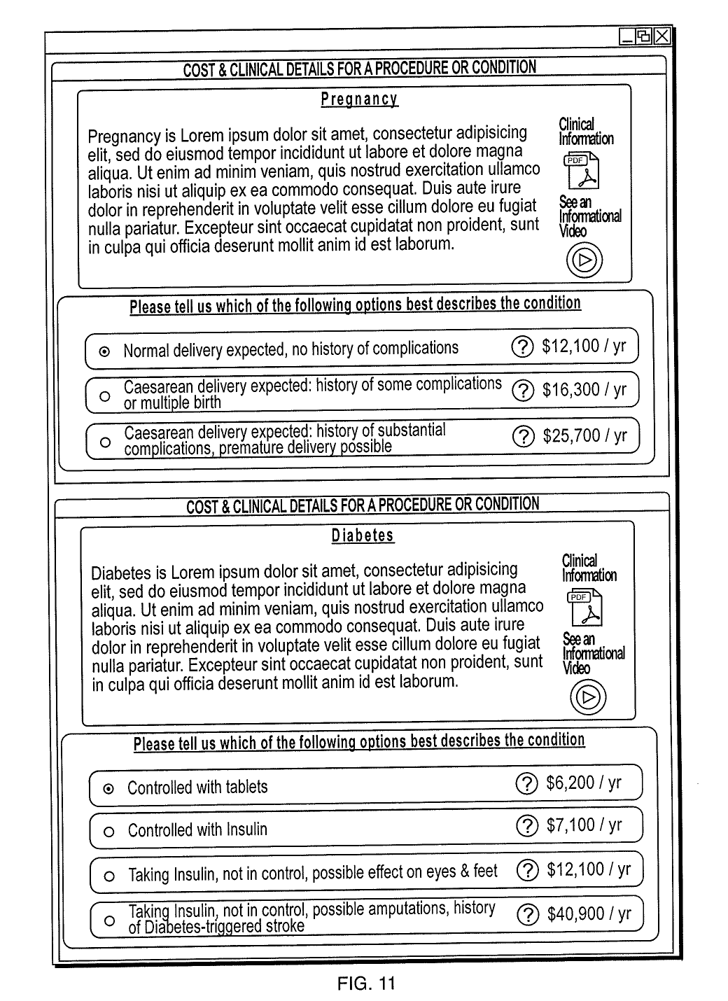

The systems and methods described herein drive healthcare product sales and personalized enrollment based on cost of care information. Some embodiments of the invention include a set of workflow activities designed to enable a sales process driven by cost of care parameters for the consumer market. Other embodiments of the invention include an engine that recommends to a consumer a healthcare product in which to enroll based on, e.g., (1) historical claims driven forecasting, or (2) survey responses to quantify cost-of-care forecasting, and/or (3) auto-population of historical ‘Health Assessment’ data into the survey (i.e., health data that the payor may have for existing or former members), and (4) a pre-defined set of claim/cost aggregation categories. FIG. 8 is exemplary. Given the specific cost-of-care forecast, the engine recommends and ranks products based, e.g., on value-for-money, based on procedure/condition complexity driven cost-of-care modeling techniques. FIG. 10 is exemplary. As shown in FIG. 10, displayed to the consumer are several plan options, ranked based on value. Also displayed to the consumer may be prescriptions, including those specifically taken by the consumer, and providers, including those chosen by the consumer, that are covered by the plan. FIG. 11 illustrates conveyance of cost-of-care modeling information based on relative complexity of procedures or conditions. As shown in FIG. 11, the consumer may choose from a list of options that best describe his/her procedure or condition with particularity; the cost associated with the particular procedure or condition chosen by the consumer is factored in (i.e., based on the complexity of the procedure or condition). Some embodiments of the invention allow for creation of multiple what-if scenario profiles to simulate different life events, coverage strategies, and treatment options. FIG. 9 is exemplary. The systems and methods described herein result in a view of recommended products and product options, personalized to the consumer. This personalized view is designed to communicate to the consumer critical cost share information in user-friendly graphics and terminology.

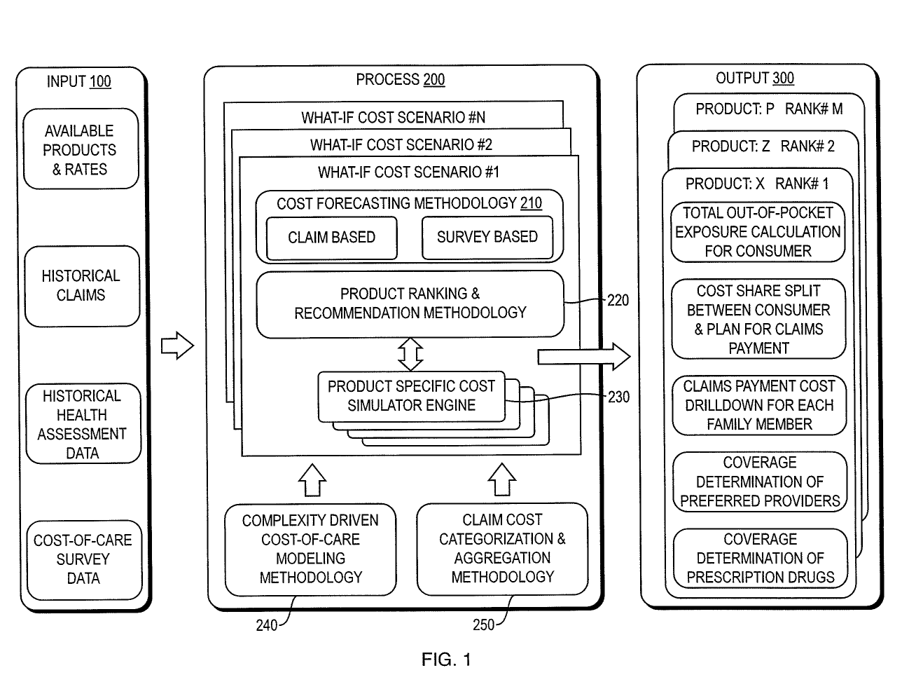

With reference to FIG. 1, the process involves use of a product-specific cost simulator engine 230. In one embodiment, this is a stateless service engine that is called for a given product and takes as inputs 100 the product benefit structure and the categorized claim cost structure per family member. The product benefit structure is an interface in which the product benefit details (e.g., network type, product type, monetary deductible limit, deductible type, co-insurance limit percentage, monetary out-of-pocket limit, monetary co-payment, benefits covered list, etc.) that are necessary for the payment calculation are expressed. The categorized claim cost structure per family member is an interface that categorizes types of claim sources (e.g., Doctor's Office, Hospitals, Pharmacies and Labs) into claim cost categories depending on specific factors (place of service, service category, doctor/Hospital/Clinic specialization, deliverable category, etc., by way of example). In one embodiment, the claim cost categories include:

Preventive office visits such as immunizations, annual health check

Non-Preventive office visits with a general or family practice doctor

Non-Preventive office visit with a specialty doctor (e.g., cardiologist)

Generic drug prescriptions

Branded drug prescriptions

Specialty restricted drug prescriptions, such as for fertility, Cancer, AIDS

Emergency room visit at a hospital

Outpatient surgery at a hospital with no overnight stay

Hospitalization with overnight stay

General lab tests

Diagnostic imaging lab tests, such as MRI, CAT scan, Sonograms

The output 300 of this engine includes a cost share split structure that shows what amount the health plan will pay and what amount the consumer will pay per family member per the cost categories (examples of which are set forth above) if the particular product is bought.

In simulating the cost split, the engine makes the following assumptions, in an exemplary embodiment. It assumes all claims will be processed in-network. If the claims are processed out-of-network, then the consumer is expected to pay the difference between the ‘reasonable and customary’ cost and the ‘billed charge’. For an out-of-network claim the ‘billed charge’ is unknown for forecasting purposes, hence the assumption is required. It further assumes all claim costs are re-priced claim charges (after applying the network discount by the health plan). This is to take the billed charge and the amount of network discount out of consideration, which varies widely and is provider-specific. Still further, it assumes the person in the family who utilizes the healthcare services more will utilize the services earlier than others. The deductible limit and out-of-pocket maximum limit dictate, among other factors, the cost that the consumer has to bear. To forecast the cost-split between the family members, the sequence in which they will visit the doctors/hospitals should be known, hence the assumption. Other assumptions may be made in accordance with the invention in order to more accurately render an output.

The cost simulator engine 230 iterates the product benefit structure elements through the claim cost structure categories for each of the family members in a specific sequence, to come up with the output.

The product ranking and recommendation engine 220 is a state-less service engine, working as a higher-level decision maker, which calls the product specific cost simulator engine 230, triggering parallel threads (one for every product) and collects the results in an array, once all the threads complete their execution. It then sorts the array in ascending order of consumer's total out-of-pocket cost (sum of monthly premium cost and monthly average claim expense cost share) to determine the final ranking. Whichever product has the lowest total out-of-pocket cost for the consumer will become the recommended product. The inputs for this engine include, in an exemplary embodiment: an array of products that are to be simulated and ranked; the monthly premium cost to be paid by the consumer, for each of the products; and categorized claim cost structure per family member. The output 300 for this engine is a sorted array of ranked and recommended products along with the total out-of-pocket cost for the consumer for each product.

The claim or survey-based cost categorization methodology 210 provides a way for the consumer to intuitively forecast the healthcare service needs for next year for each member of his family, either via reviewing their historical claims or via responses to a survey, at the choice of the consumer. The methodology involves collecting the claim data or the survey data from the consumer, analyzing it, and converting it into a set of standardized healthcare service categories that can be subsequently used in downstream processing. The methodology produces the same output structure no matter which process the consumer used (i.e., reliance on claim data or survey data). For each of the chronic conditions or procedures that are chosen by the consumer in the survey, the complexity driven cost of care modeling engine is called to produce the standard categorized cost structure.

In the exemplary embodiment, the survey asks between several questions for each of the family member, depending on relevance, as needed, for example:

Overall Health:
Healthy, no chronic conditions
Some chronic problems that need to be managed (collect number of office visits, ER visits, and hospital visits last year)

Identify (e.g., from a list) any prescription taken regularly

Identify (e.g., from a list) pre-existing chronic conditions (Diabetes, heart condition, cancer etc.). This question may only be presented if the consumer has indicated in the first question that he/she has some chronic condition that needs to be managed.

Identify (e.g., from a list) planned/probable procedures for next year (pregnancy, hip replacement, hysterectomy, etc.)

Identify (e.g., from a list) preferred providers.

The cost categorization methodology 250 classifies four types of claim sources (Doctor's Office, Hospitals, Pharmacies and Labs) into the following claim cost categories, in the exemplary embodiment, depending on specific factors (place of service, service category, doctor/Hospital/Clinic specialization, deliverable category etc):

Preventive office visits such as immunizations, annual health check

Non-Preventive office visits with a general or family practice doctor

Non-Preventive office visit with a specialty doctor, such as Cardiologist, Gastroenterologist

Generic drug prescriptions

Branded drug prescriptions

Specialty restricted drug prescriptions, such as for fertility, Cancer, AIDS

Emergency room visit at a hospital

Outpatient surgery at a hospital with no overnight stay

Hospitalization with overnight stay

General lab tests

Diagnostic imaging lab tests, such as MM, CAT scan, Sonograms

The complexity driven cost-of-care modeling engine 240 is a state-less service engine that expresses the cost-of-care of a procedure (like a surgery) or a condition (like Diabetes or heart disease) in a standard categorized claim cost structure for a finite range of predetermined complexity tiers. The input to this engine is the name of the condition or procedure. The outputs include:

(1) Complexity Tiers: This is a methodology that assigns predetermined tiers to different levels of complexity that may occur in a procedure or condition. The cost-of-care will vary significantly between the different tiers. For example, the complexity tiers for Diabetes could be: Controlled with tablets; Controlled with Insulin; Taking Insulin, not in control, possible effect on eyes and feet; Taking Insulin, not in control, possible hospitalizations, amputations, history of Diabetes-triggered stroke. Another example of the complexity tiers for Maternity could be: Normal delivery expected, no history of complications; Caesarean delivery expected: history of some complications or multiple births; Caesarean delivery expected/history of substantial complications, premature delivery possible.

(2) Categorized Claim Cost Structure: This is an interface that categorizes four types of claim sources (Doctor's Office, Hospitals, Pharmacies & Labs) into, e.g., the following eleven well-defined claim cost categories depending on specific factors (place of service, service category, doctor/Hospital/Clinic specialization, deliverable category etc):

Preventive office visits such as immunizations, annual health check

Non-Preventive office visits with a general or family practice doctor

Non-Preventive office visit with a specialty doctor, such as Cardiologist, Gastroenterologist

Generic drug prescriptions

Branded drug prescriptions

Specialty restricted drug prescriptions, such as for fertility, Cancer, AIDS

Emergency room visit at a hospital

Outpatient surgery at a hospital with no overnight stay

Hospitalization with overnight stay

General lab tests

Diagnostic imaging lab tests, such as MRI, CAT scan, Sonograms

The tiering methodology is based on determining the yearly cost for a condition and on episodal cost of a procedure, as well as on recognizing the incremental complexity of a condition/procedure. This goes beyond the cost of a just specific surgery or doctor visit, but takes into account the ancillary necessary costs (e.g., the cost of 2-months of physiotherapy sessions, necessary imaging needs, and the Titanium alloy replacement hipbone on top of the surgery cost for a hip replacement procedure). This type of data is collected and categorized by software on a very large volume of claims that had the related CTP/HICPC code, ICD9 diagnosis code, ICD9 surgery procedure code, place of service code combinations. For each of the chronic conditions or procedures that have been chosen by the consumer in the survey, this complexity driven cost of care modeling engine will be called to produce the standard categorized cost structure.

The methods and systems, in some embodiments, allow the consumer to create multiple ‘what-if’ scenario profiles to forecast cost: The system offers to the consumer an easy way to perform multiple situational forecasting scenarios depending on, e.g.:

Which family members will be covered

Which optional or life-changing event may happen next year, e.g., a pregnancy, any high priced surgical procedure like knee/hip replacement

How the consumer wants to forecast: Claim based way or the survey based way

The system may store all the ‘what-if’ scenarios that the consumer has created and will let the consumer run the product recommendation process on any of those. This produces the recommended product for every ‘what-if’ scenario, each of which may differ from the others depending on the degree of difference between the scenarios.

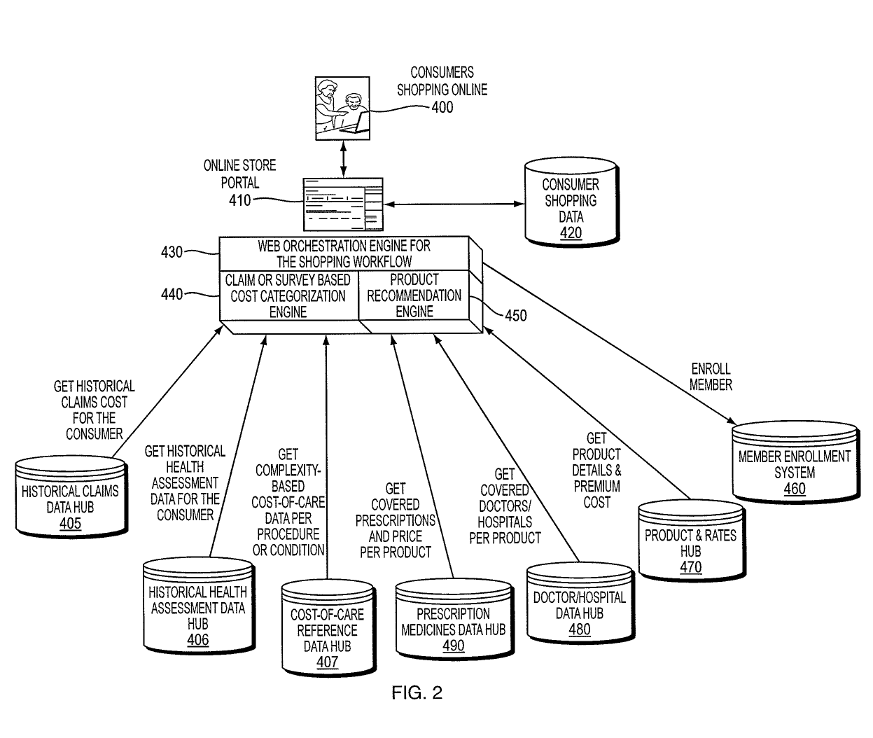

With reference to FIG. 2, an exemplary system diagram is shown. Consumers 400 may shop on line accessing the online store portal 410. Data relating to their shopping experience is stored in database 420. A web orchestration engine 430 is used to implement the shopping workflow. Claim/survey based cost categorization engine 440 and product recommendation engine 450 implement the functionality described herein. The illustrated databases hold historical claims data (database 405); historical health assessment data (database 406), cost-of-care reference data (database 407), prescription medicines data (database 490), doctor/hospital data (database 480), product and rates data (database 470) and member enrollment data (enrollment system 460).

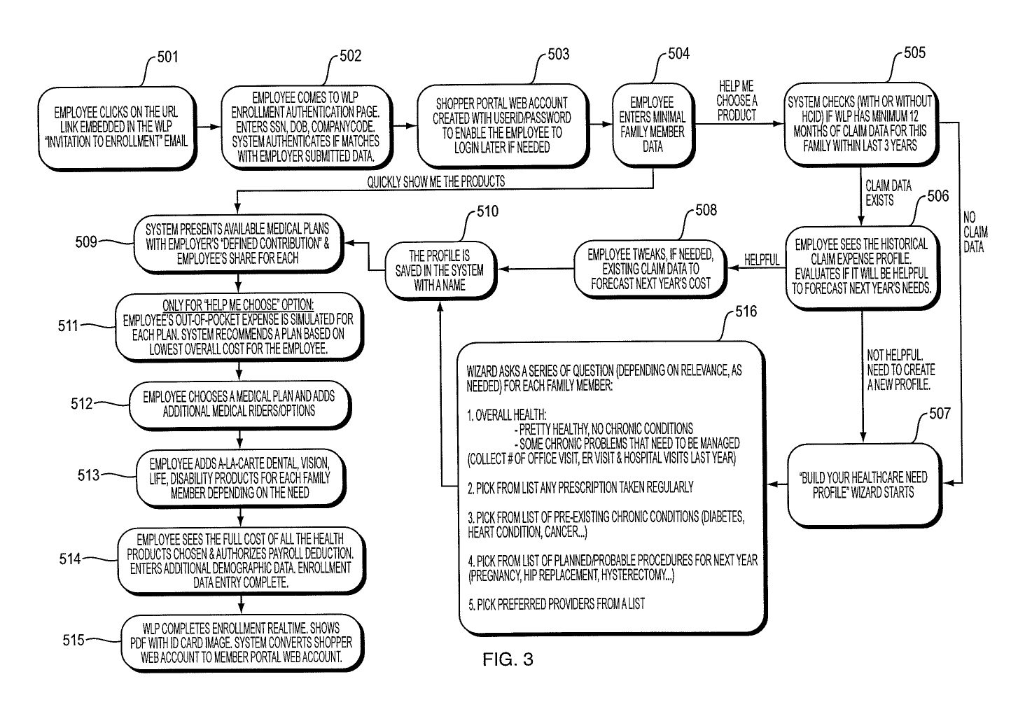

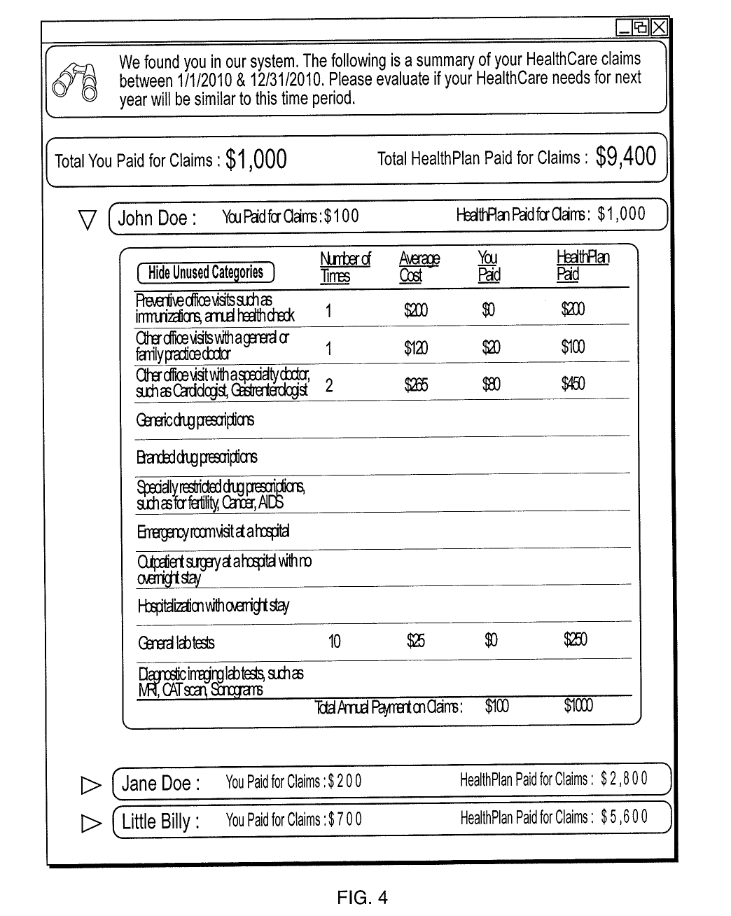

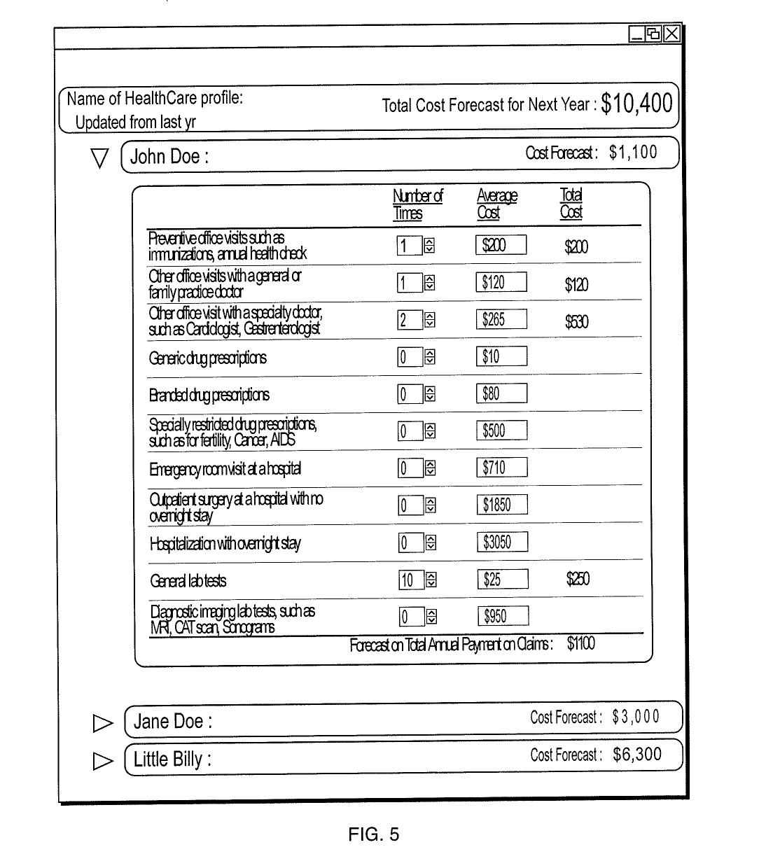

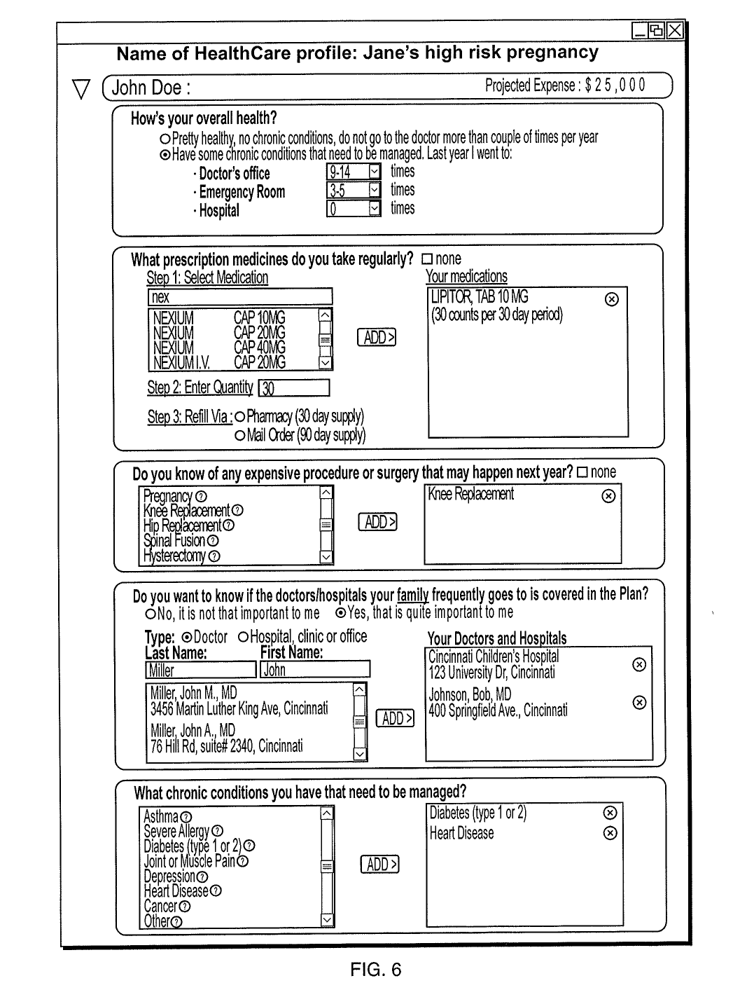

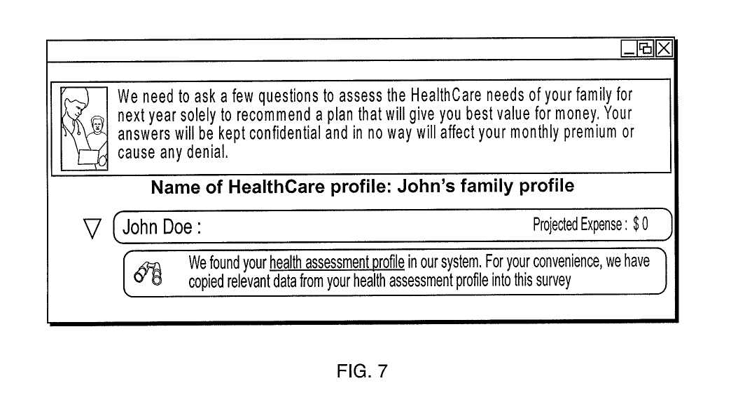

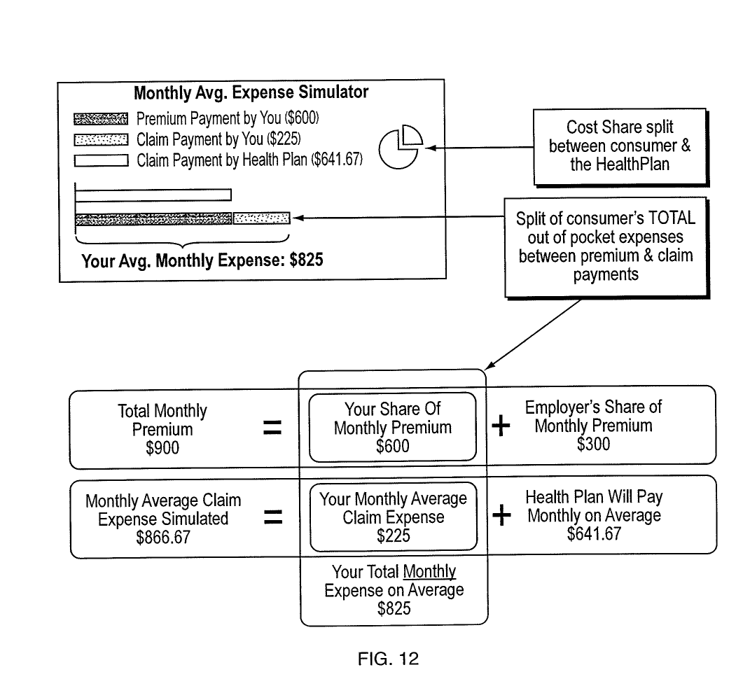

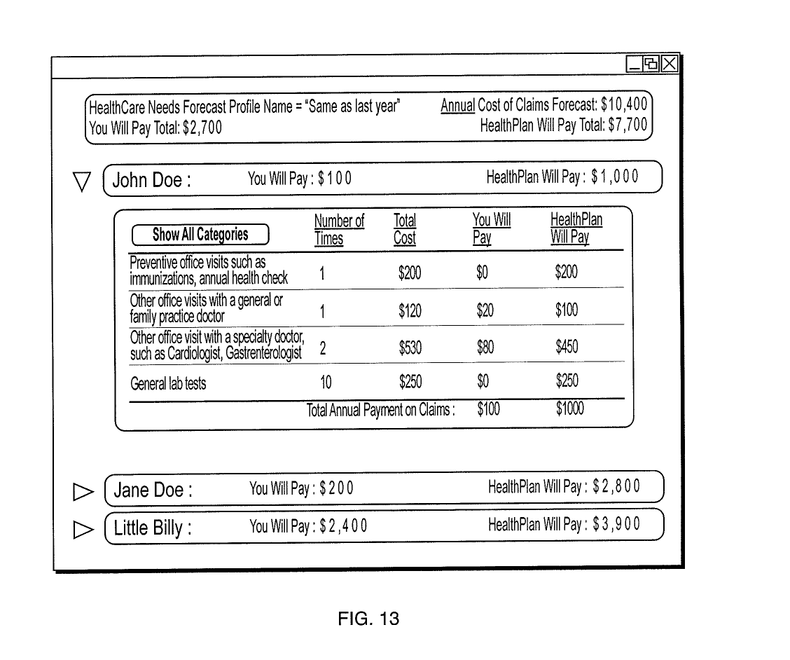

With reference to FIG. 3, an exemplary method of the present invention is illustrated. In step 501, the employee clicks on the URL link embedded in an “invitation to enrollment” email. In step 502, the employee arrives at the enrollment authentication page, where he enters his social security number, date of birth, and company code. The system authenticates the employee if his data matches that submitted by the employer. In step 503, a shopper portal web account is created with a userid/password to enable the employee to log in later if needed. In step 504, the employee enters family member data, if any. If the employee wishes to employ the tool to assist it in choosing a product, the process moves to step 505. In step 505, the system checks whether the payor/health insurer has a minimum of, e.g., 12 months, of claim data for the family within the last, e.g., 3 years. If so, in step 506, the employee sees his historical claim expense profile and evaluates if it will be helpful to forecast next year's needs. An exemplary screen is shown in FIG. 4, which illustrates the historical claims driven forecasting. If not helpful, then the consumer will need to create a new profile. In step 507, the Build your HealthCare Need Profile wizard starts. Also, if there is not sufficient claims data, the process moves to step 507. In step 516, the wizard asks a series of questions for each family member, examples of which are illustrated in step 516 of FIG. 3 and illustrated in FIG. 6 (i.e., a survey to quantify cost-of-care forecasting). Such exemplary questions include allowing the consumer to specify which prescription medicines are taken regularly, any anticipated procedures or surgeries, preferred providers, and chronic conditions to be managed. In some embodiments, the process also determines (and may display to the consumer) whether the specified providers will be covered by the plan options that are presented With reference to FIG. 7, historical health assessment data may be auto-populated into the survey. Returning again to step 506, if it is determined that it will be helpful to the consumer to forecast next year's needs, in step 508, the consumer may alter the existing claim data to forecast next year's cost. An exemplary screen is shown in FIG. 5. In some exemplary embodiments, the consumer may input information to augment the claims data-driven assessment with specific information chosen by the consumer regarding, e.g., particular prescriptions taken by the consumer, including whether the generic or brand name is desired, and any of the consumer's preferences regarding providers (e.g., hospitals or doctors). Rating information about the provider(s) may also be displayed to the consumer to assist the consumer in specifying providers of interest. In step 510 (which occurs either after step 508 or step 516), the profile is saved in the system. In step 509 (either after the employee has created a profile, in step 510, or after the employee enters family information and asks that products be shown in step 504), the system presents available medical plans identifying the employer's defined contribution and the employee's share for each. In step 511, assuming the employee chose the “help me choose” path in step 504, the employee's out-of-pocket expense is simulated for each plan. The system then recommends a plan based on the lowest overall cost for the employee. FIG. 12 is an example of the cost disclosure user interface graphics. FIG. 13 is exemplary of the drilldown of cost split per treatment category for every family member. In step 512, the employee chooses a medical plan and adds additional medical riders/options. In step 513, the employee adds a-la-carte dental, vision, life, and/or disability products for each family member depending on the need. The systems that allow the consumer to select the appropriate health care product can be seamlessly integrated into the enrollment process. In particular, in step 514, the employee sees the full cost of all the health products chosen and authorizes payroll deduction. The employee may enter additional demographic data. At this point, enrollment data entry is complete. In step 515, the enrollment is processed by the payor/health insurer and a PDF may be shown to the employee with an image of the ID card. The system then converts the shopper web account to a member portal web account, in step 515.

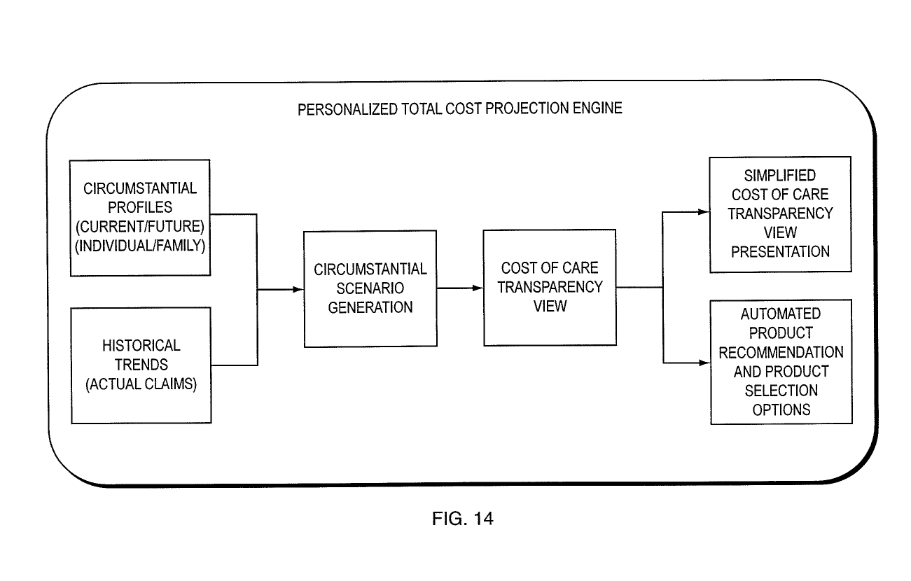

FIG. 14 is a diagram illustrating the personalized total cost projection engine of the present invention and how it allows for transparency into personalized cost of care. The personalized total cost projection engine is capable of determining cost of care projections and creating personalized cost of care transparency views for consumers. The engine creates personalized views of individual and family oriented cost of care, which allows consumers make informed decisions on healthcare product selections. The engine employs as its inputs detailed, specific, real-life information about healthcare conditions and circumstances, and, thus, relies on clinically rigorous data to make its determinations. In particular, it uses circumstantial profiles (e.g., current and/or future profiles of an individual/individual's family), along with actual claims data reflecting historical trends, to generate possible cost scenarios. The engine then reviews the cost of care, which is then simplified to present to the consumer, along with product recommendation/selection options.

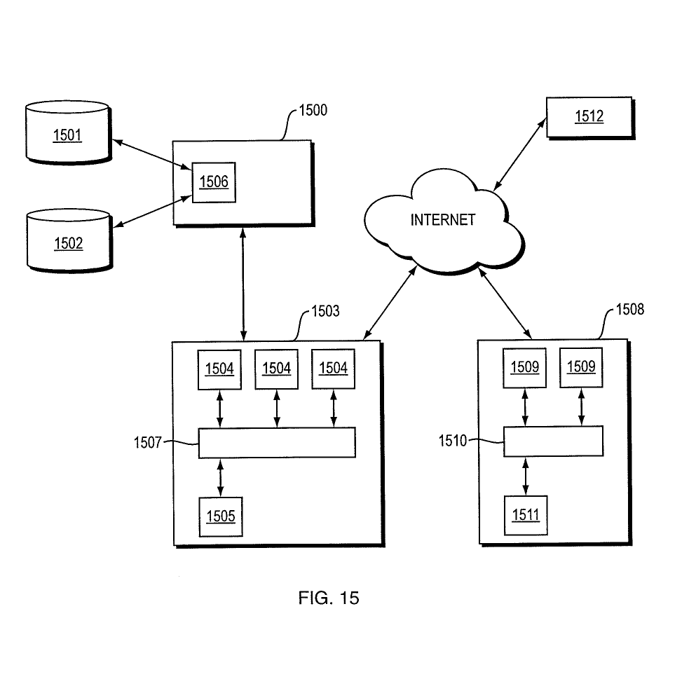

Exemplary hardware and software employed by the systems are now generally described with reference to FIG. 15. Database server(s) 1500 may include a database services management application 1506 that manages storage and retrieval of data from the database(s) 1501, 1502. The databases may be relational databases; however, other data organizational structure may be used without departing from the scope of the present invention. One or more application server(s) 1503 are in communication with the database server 1500. The application server 1503 communicates requests for data to the database server 1500. The database server 1500 retrieves the requested data. The application server 1503 may also send data to the database server for storage in the database(s) 1501, 1502. The application server 1503 comprises one or more processors 1504, computer readable storage media 1505 that store programs (computer readable instructions) for execution by the processor(s), and an interface 1507 between the processor(s) 1504 and computer readable storage media 1505. The application server may store the computer programs referred to herein.

To the extent data and information is communicated over the Internet, one or more Internet servers 1508 may be employed. The Internet server 1508 also comprises one or more processors 1509, computer readable storage media 1511 that store programs (computer readable instructions) for execution by the processor(s) 1509, and an interface 1510 between the processor(s) 1509 and computer readable storage media 1511. The Internet server 1504 is employed to deliver content that can be accessed through the communications network, e.g., by end user 1512. When data is requested through an application, such as an Internet browser, the Internet server 1508 receives and processes the request. The Internet server 1508 sends the data or application requested along with user interface instructions for displaying a user interface.

The computers referenced herein are specially programmed to perform the functionality described herein as performed by the software programs.

The non-transitory computer readable storage media may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system.

What is claimed is:

1. A computer implemented method comprising:
receiving data describing health profile information from a consumer;
based on the data describing the health profile information, determining data describing cost of care information;
based on the cost of care information, determining at least one recommended health care coverage product for the consumer.

2. The computer-implemented method of claim 1, wherein the health profile information is based on historical claims information for the consumer.

3. The computer-implemented method of claim 1, wherein the health profile information is based on responses to survey from the consumer.

4. The computer-implemented method of claim 1, wherein the health profile information relates to the consumer and at least one dependent of the consumer.

5. The computer-implemented method of claim 1, further comprising:
conveying to the consumer a consumer cost associated with each of the recommended health care coverage products.

6. A system comprising:
memory operable to store at least one program; and
at least one processor communicatively coupled to the memory, in which the at least one program, when executed by the at least one processor, causes the at least one processor to:
receive data describing health profile information from a consumer;
based on the data describing the health profile information, determine data describing cost of care information;
based on the cost of care information, determine at least one recommended health care coverage product for the consumer.

7. The system of claim 6, wherein the health profile information is based on historical claims information for the consumer.

8. The system of claim 6, wherein the health profile information is based on responses to survey from the consumer.

9. The system of claim 6, wherein the health profile information relates to the consumer and at least one dependent of the consumer.

10. The system of claim 1, the method further comprising:
conveying to the consumer a consumer cost associated with each of the recommended health care coverage products.

11. A non-transitory computer-readable storage medium that stores instructions which, when executed by one or more processors, cause the one or more processors to perform a method comprising:
receiving data describing health profile information from a consumer;
based on the data describing the health profile information, determining data describing cost of care information;
based on the cost of care information, determining at least one recommended health care coverage product for the consumer.

12. The non-transitory computer-readable storage medium of claim 13, wherein the health profile information is based on historical claims information for the consumer.

13. The non-transitory computer-readable storage medium of claim 13, wherein the health profile information is based on responses to survey from the consumer.

14. The non-transitory computer-readable storage medium of claim 13, wherein the health profile information relates to the consumer and at least one dependent of the consumer.

15. The non-transitory computer-readable storage medium of claim 13, further method comprising:
conveying to the consumer a consumer cost associated with each of the recommended health care coverage products.
